(19) United States
(12) Patent Application Publication
(10) Pub. No.: US 2022/0132842 A1
(43) Pub. Date: May 5, 2022

(54) COATING COMPOSITION FOR SEED

(71) Applicant: SEEDFORWARD GMBH, Quakenbrueck (DE)

(72) Inventors: Jaoob Paul BUSSMANN, Quakenbrueck (DE); Jan RITTER, Quakenbrueck (DE)

(21) Appl. No.: 17/433,906

(22) PCT Filed: Feb. 26, 2020
(86) PCT No.: PCT/EP2020/054998

§ 371 Date: Aug. 25, 2021

(30) Foreign Application Priority Data
Feb. 26, 2019 (DE) 10 2019 104 867.2

(51) Int. Cl. A01N 37/02; A01N 65/08; C05G 5/23; C05G 5/27; C05F 11/08; C05F 11/02

(52) U.S. Cl. CPC A01N 37/02; A01N 65/08; C05F 11/02; C05G 5/27; C05F 11/08; C05G 5/23

(57) ABSTRACT

The invention relates to a composition for a seed coating, comprising a liquid component, containing at least one binder, at least one plant oil, at least one interface-active substance, at least one carboxylic acid, and at least one extract from plant material. The invention also relates to a method for producing coated seed and the use of the composition to coat seed, for improved growth.

The invention relates to a coating composition, especially for seed, for improving the metering ability and growth conditions of the seedling.

The treatment of seeds with germination or growth-improving substances offers an efficient method for increasing crop yields, especially of agricultural crops.

Various active substances are known that have a positive effect on growth parameters such as germination, resistance to diseases and pests, growth, and ultimately, yield.

The specialist literature indicates a large number of special solutions for the respective plant species.

Certain active substances are known for their outstanding effects on plant growth and development.

CN104609939 discloses a liquid fertilizer which stores water and increases the yield on plants. This is produced by fermentation and subsequent extraction of borax, humate, wood vinegar, edible mushroom sediment and plant material with water at an elevated temperature. Adding brassinolide and indole butyric acid can promote the growth of plant roots and increase the survival rate. The addition of mushroom waste, grass coal, Hylocereus undatus and other organic raw materials contributes to the water storage capacity and fertility of the soil.

The use of humic acids from humus as growth promoters has been disclosed in several studies. A summary can be found on the page http://www.darostim.de/humus.htm, for example

Ling, J Enchen, L Jian—Journal of Maize Sciences, 2008—agris.fao.org—discloses the positive effects of wood vinegar on the germination and growth of plants.

K. Sadakichi and T. Hiorowaka describe in an online publication of a scientific paper the advantages of biochar and wood vinegar on the growth of plants or the improvement of the soil quality. (Please see: www.warrencc.org.au/wp-content/uploads/2015/12/CharcoalVinegar-with-pictures.pdf).

These active substances can be introduced into the soil before or after sowing. However, this often results in metering errors as a disadvantage. Methods have therefore been developed to adapt the amount of active substance to the needs of the seed.

WO 2007/0014606 A2—discloses a composition with disinfecting and stabilizing substances for use as a disinfectant. This can additionally contain at least one insecticidal substance. Their use as an insecticide is also disclosed.

The main component of the composition is hydrogen peroxide, to which various organic acids can be added depending on the area of application. In addition to the disinfecting effect, this also has a fungicidal or virocidal effect.

The addition of insecticidal substances enables an insecticidal composition to be obtained which is also very stable due to the disinfecting effect of the other components.

The addition of plant extracts increases the insecticidal effect of the composition. The plant extracts themselves do not show any insecticidal effects.

DE 10 2005 060 449 A1 discloses carboxamides and methods for their production. The use of the compounds for combating undesirable microorganisms such as fungi and bacteria in crop protection is also disclosed. For this purpose, all parts of the plant, including the seeds, are treated with the compounds. This is done, among other things, by dissolving the active ingredients in common solvents.

NL1012918 C2 discloses a method for protecting germinating seed by pesticides. Since pesticides usually have a phytotoxic effect, the pesticides are incorporated into pellets which have the same diameter as the pelleted seeds. The sowing is carried out in such a way that the seed and pellet are introduced into the soil in pairs.

US 20120272132 A1 discloses a granulate containing neem seed oil and silicon, which is introduced into the seed furrows before the actual seed is planted and thus increases the resistance of the plants to diseases and pests.

Coating the seed with a coating has also been shown to improve germination and growth.

DE 102013210408 A1/WO2014195123A1 discloses a method for producing granulated seed, wherein a binder, for example a polyvinyl alcohol or starch, is applied to the seeds first and then a coating material comprising silica is applied. The coating material can also contain a hygroscopic salt such as magnesium chloride. The embodiments show that the rapeseed granulated according to the patent specification has a similarly high germination capacity as ungranulated, pure rapeseed.

WO002010107312A1 discloses a seed coating containing inorganic particles with an average size of 250 μm. The particles are preferably silicates or carbonates. The addition of these particles to a polymer coating prevents the coated seeds from sticking to one another.

The combination of both concepts offers a particularly efficient approach, with the active substance being incorporated into the seed coating.

US 2012/0220454A1 discloses a seed coating containing at least one seed and at least one layer containing a polymer such as polyacrylamide or a polymerizable compound such as starch, and in one embodiment a binder such as polyvinyl alcohol or a rubber mixture. It can also contain an active substance such as herbicides, bacteriocides or glyphosate and fillers such as clay or activated charcoal.

DE 698 36 886 T2 discloses an insecticidal coating for a seed comprising binders, fillers and an insecticide. The amount of the binder is preferably 0.01 to 15 percent by weight. This binder forms the matrix for the filler and insecticide. In order to avoid a phytotoxic effect, the proportion of the binding agent must be as high as possible. The insecticide represents 0.005 to 50 wt. % of the seed.

Optionally, a film coating can be applied to the coated seed. This coating serves to protect the coated layers. The coating film can also contain oils or emulsifiers, among other things

U.S. Pat. No. 5,106,648 A1 discloses a method for producing coated seeds, wherein the seeds first are wetted with a carrier medium. This carrier medium contains microorganisms that stimulate plant growth and a polymer. In order to keep the microorganisms alive, an elaborate coating process is necessary. A suspension of a second polymer is then applied. At the end, the coated seeds are dried at 30° C.

The seed coated in this way shows improved growth and the plants show increased crop yields.

CN1799361A discloses a seed coating based on silica gel, sodium benzoate, octanol, and ethylene glycol containing 3 to 8% of a fungal protein and 0.3 to 5% humic acids. Seed coated with this will show improved germination and growth.

DE 689 15 423 T2 discloses seed coatings and a method for inoculating seeds with microorganisms. For this purpose, the seeds are slurried in a suspension of microorganisms, polymer and carrier medium and coated with it.

JPH1160422A describes a biological seed coating containing a layer-forming substance such as starch and wood vinegar. In one embodiment, charcoal powder is also included.

US20100267554A1 discloses a seed coating containing at least one wetting agent such as butoxyethanol or B-complex vitamins. Humic acids are also mentioned in this context.

The disadvantage of the seed coatings, depending on the size of the seeds, is that they can only be applied to the seed in very thin layers, so that it is often necessary to add more active substances.

The object of the invention is to provide a seed coating which enables improved germination, resistance to diseases and pests, and growth of the plants developing from the seed. In addition, the coating should be able to be applied to the seed with a high load.

The object is achieved by a composition for a seed coating, comprising a liquid component, containing
at least one binding agent,
at least one plant oil
at least one interface-active substance
at least one carboxylic acid
at least one extract from plant material

In one embodiment, the liquid component is a solution or suspension in an aqueous and/or organic solvent. Organic solvents can be, for example, ethanol, isopropanol, glycerine or mixtures of these.

In one embodiment, the proportion of solvent is 15 to 60 m %, preferably 20 to 40 m %, based on the total mass of the liquid component.

In one embodiment, the solvent is water.

In one embodiment, the binder is selected from compounds suitable for crosslinking, such as polymer compounds or polymerizable compounds. In one embodiment, the polymerizable compounds are pre-crosslinked monomers. In one embodiment, the polymer compounds are selected from polyalcohols, polyamides; polyurethanes and/or polyacrylates.

In one embodiment, the polymer compounds or polymerizable compounds form a matrix for the further components of the coating composition.

In one embodiment, the polymer compounds are selected from polyvinyl alcohols and their copolymers, polyvinyl acetates and their copolymers, starches, polyacrylamides and their copolymers, polyacylates and their copolymers, polyethylene glycol, methyl cellulose derivatives (carboymethyl cellulose, etc.), xanthan gum derivatives, alginates, Chitosans, gum arabic, cellulose and cellulose derivatives, polyvinylpyrollidinones, dextrins and their derivatives, polysaccharides, fats, oils, proteins, shellacs, vinylidene chlorides and their copolymers, lignosulphonates, acrylates and their copolymers and/or mixtures of these.

In one embodiment, the mass fraction of the binder is 15 wt. % to 70 m %, preferably 40 to 70 m %, particularly preferably 55 to 70 m % of the total mass of the liquid component.

The specification m % means mass fraction of the total mass in %.

In one embodiment, the binder is suspended and/or dissolved in a solvent, preferably water.

According to the invention, the liquid component contains at least one plant oil.

In one embodiment, the plant oil contains at least one essential oil.

Here, essential oils are secondary plant constituents, which form extracts soluble in organic solvents or the organic phase from steam distillates from plants or parts of plants and have a strong odor that is characteristic of the plant of origin. Essential oils mostly consist of mixtures of different terpenes, terpenoids, sesquiterpenes or aromatic compounds (e. g. phenylpropane derivatives). They are fat-soluble, but do not contain any fats. In contrast to fatty oils, such as triglycerides and fatty acid esters, essential oils evaporate without leaving any residue. They are only very sparingly soluble in water. At normal pressure, the boiling point of essential oils and their components is higher than that of water, but they are overdistilled by superheated steam. They usually have a lower density than water and therefore form phases (drops, films & layers) floating on the surface of the water.

In one embodiment, the plant oil contains terpenes.

In one embodiment, the plant oil is selected from sunflower seed oil, rapeseed oil, linseed oil, canola oil, soybean oil, coconut oil, cotton oil, palm oil, olive oil, sesame oil, chamomile oil, cinnamon oil, lavender oil, oregano oil, eucalyptus oil, citrus seed oil, basil oil, mint oil, thyme oil, anise oil, fennel oil, wintergreen oil, tea tree oil, jojoba oil, birch tar oil, chamomile oil, ylang-ylang oil, bitter orange blossom oil, orange blossom oil, rosemary oil, garlic oil, Pongamia pinnata oil and/or mixtures of these.

In one embodiment, the mass proportion of the plant oil or plant oils is 0.1 to 5 m %, preferably 0.2 to 2 m %, particularly preferably 0.3 to 1.5 m % of the total mass of the liquid component.

According to the invention, the liquid component contains at least one interface-active substance. In the context of the invention, the term “interface-active substance” encompasses compounds which have both hydrophilic and hydrophobic areas within their chemical structure. They thus act as intermediaries between compounds within the liquid component that are otherwise immiscible or difficult to mix.

In one embodiment, the at least one interface-active substance is selected from emulsifiers, surfactants, wetting agents, dispersants and/or mixtures of these.

Wetting agents can be, for example, lecithin, terpenes, glycosides, glycosaminoglycans, phospholipids.

In one embodiment, the at least one interface-active substance is selected from sulfonic acid derivatives, fatty acid derivatives; oleic acid derivatives, monoglycerides, diglycerides, triglycerides, alkoxylates, polyolefins, cationic or anionic salts, polyalcohols, polyethers, alcohols, carboxylic acids and/or mixtures of these.

In one embodiment, the mass proportion of the at least one interface-active substance is 0.05 to 0.1 m % of the total mass of the liquid component.

According to the invention, the liquid component contains at least one carboxylic acid, preferably with 1 to 10, particularly preferably with 1 to 5 carbon atoms.

In one embodiment, the carboxylic acid is selected from aromatic and/or aliphatic carboxylic acids and/or mixtures of these.

For the purposes of the invention, aromatic carboxylic acid means that the carboxyl group is located directly on the aromatic ring. The aromatic ring can be a 5- or 6-membered ring. It can be monocyclic as well as bi- or polycyclic aromatics, such as naphthenes.

In one embodiment, the carboxylic acid contains at least one substituted or unsubstituted carboxyphenyl unit.

In one embodiment, the aromatic carboxylic acids are selected from salicylic acid, cinnamic acids, caffeic acid, ascorbic acid, coumaric acid and/or mixtures of these . . . .

Aliphatic carboxylic acid in the context of the invention means that the carboxyl group is connected to a further structural unit, for example a substituted or unsubstituted, aliphatic or aromatic radical, via at least one CH2 group.

In one embodiment, the aliphatic carboxylic acids are selected from acetic acid, malic acid, oxalic acid, tartaric acid, formic acid and/or propionic acid and/or mixtures of these.

In one embodiment, the liquid component contains acetic acid and/or one or more other short-chain (C1 to C5) organic acids, preferably in combination with at least one further compound selected from alcohols, e.g. methanol, phenols, e.g. cresol, ketones, e.g. acetone, carboxylic acid esters, for example methyl acetate and/or mixtures of these.

In one embodiment, the liquid component additionally contains capsaicin.

In one embodiment, the liquid component contains wood tar, which contains water-insoluble organic substances formed during pyrolysis.

In one embodiment, the mass of the carboxylic acid in the liquid component is 0.01 to 5%, preferably 0.01 to 1%, particularly preferably 0.01 to 0.5% of the total mass of the liquid component.

In one embodiment, the liquid component contains Acetum lignorum and/or Acetum pyrolignosum, also called wood vinegar. Wood vinegar is a distillation product formed during the pyrolysis of wood, also known as smoldering water.

Short-chain (C1 to C5) organic acids advantageously enable the liquid component to penetrate better into the seed.

According to the invention, the liquid component contains at least one extract from plant material. For the purposes of the invention, the extract is selected from fluid extract, dry extract and/or thick extract or a mixture of these. In one embodiment, the extract contains ingredients of the plant material which have been extracted from the plant material by extraction with aqueous or organic solvents. Various extraction methods are known to the person skilled in the art.

Plant material in the sense of the invention corresponds to fresh plant material and/or composted plant material and/or dried plant material with or without residual moisture and/or plant material in connection with or in a mixture with animal excrement.

In one embodiment, the plants of the plant material are selected from Salix spp., Betula spp., Urtica spp., Equisetum spp., Symphytum spp., Marchantiophyta spp., Tanacetum spp., Valeriana spp., Taraxacum spp., Achilleas pp., Artemisia spp., Filipendula spp., Saponaria spp., Echinops spp., Aloe spp., Rheum spp., Silene spp., Rhamnus spp., Azolla spp., Nicotiana spp., Bucida spp., Geranium spp., Xanthoxylum spp., Maticaria spp., Phaeophyta spp., Ecklonia spp., Chlorobionta, Gaultheria spp., Phyllanthus spp., Breonadia spp., Harpephyllum spp., Olinia spp., Vangueria spp., Xylotheca spp., Piper spp., Cinnamomum spp. Clerodendron spp. Croton laccifer, Polygonum spp. Cycas circinalis, Shorea robusta, Colocasia esculenta, Citrus spp., Moringa spp., Cannabis spp. Vitex spp., Tephrosia spp., Tetranychus spp., Calotropis spp., Eugenia spp., Rosmarinus spp., Chrysopogon spp., Yucca spp., Phaeophyceae spp., Laminariales spp., Vetiveria spp., Saponaria spp., Ruta spp., Olea spp., Urginia spp., Lavendula spp., Gentiana spp., Bambusoideae spp., Puerarda spp., Silybum spp., Cynara spp., Cyamopsis spp., Capsicum spp., Veratrum spp., Helleborus spp., Syzygium spp., Brassica spp., Humulus spp., Juniperus spp., Monarda spp., Tulipa spp., Macleaya spp., Satureja spp., Fallopia spp., Persicaria spp., Cymbopogon spp., Ocimum spp., Calocedrus spp., Asarum spp., Curcuma spp., Myristica spp., Nepenthes spp., Catalpa spp., Angelica spp., Hemoiedema spp., Pongamia spp., Pachyrhizus spp., Annona spp., Derms spp., Lonchocarpus spp., Tagetes spp., Crotalaria spp., Chrysanthemum spp., Ricinus communis, Laurus spp., Citrullus spp., Myrtus spp., Tsuga spp., Schoenocaulon spp., Sambucus spp., Thymus spp., Sylvia spp., Jatropha spp., Nigella spp., Alpinia spp., Gomphrena spp., Mirabilis spp., Hyptis spp., Zingiber spp., Lantana spp., Ryania spp., Sapindus spp., Diploknema spp., Tymbra spp., Cryptomeria spp., Magnolia spp., Glycyrrhiza spp., Cynanchum spp., Euphorbiaceae spp. and/or mixtures of these.

In one embodiment, the plant material is selected from compost and/or humus from plants or plant material. In one embodiment, the plant material is selected from a mixture of plant material and animal excrement.

In one embodiment, the extract is an aqueous extract from plant material. Methods for obtaining aqueous extracts from plant material are known to the person skilled in the art.

In one embodiment the extract is a dry extract from plant material.

In one embodiment, the extract is an aqueous solution which is obtained by mixing, preferably comminuted, plant material and water in a ratio of 1:1 to 1:50, preferably 1:1 to 1:20 (v/v), and afterwards the solids are separated from the resulting aqueous solution, for example by filtration, over a period of from 1 minute to 72 hours, preferably from 5 hours to 48 hours.

In one embodiment, the extract contains microorganisms and/or nutrients with growth-promoting properties for microorganisms.

In one embodiment, the liquid component additionally contains microorganisms.

In one embodiment, the liquid component additionally contains microorganisms and nutrients for cultivating microorganisms. In one embodiment, these are selected, for example, from carbohydrates, proteins, micronutrients and/or humates.

In one embodiment, the liquid component contains humates.

In one embodiment, the humates are selected from the salts of high molecular weight humic acids. In one embodiment, the humates are selected from the salts of low molecular humic acids.

In one embodiment, the amount of nutrients is 0.05 to 5 m %, preferably 1.1 to 2.5 m %, in particular 1.3 m %, based on the total mass of the liquid component.

In one embodiment, the microorganisms are selected from bacteria, yeasts and/or fungi.

The microorganisms were added to the liquid component, for example in aqueous suspension and/or in dry form, for example freeze-dried.

In one embodiment, the bacteria are selected from gram-positive bacteria, gram-negative bacteria, nitrogen-fixing bacteria and/or phosphorus-mobilizing bacteria.

In one embodiment, the microorganisms are a mixture of vermicompost derived microorganisms.

In one embodiment, the bacteria are selected from Bacillus spp., B. megaterium; B. pumilus, B. subtili, Nitrobacter, Rhizobiales spp., Azotobacter, α-Proteobacteria, β-Proteobacteria, γ-Proteobacteria, Actinobacteria, Planktomycetes, Firmicutes, Bacteroidetes, Bacillus benzoevorans, B. cereus, B. licheniformis, B. megaterium, B. pumilus, B. subtilis and/or, B. macroide.

In one embodiment, the yeasts are selected from Geotrichum spp and/or Williopsis californica, Kluyveromyces lactis, Saccharomyces cerevisiae, and/or Sporobolomyces roseus.

In one embodiment, the fungi are selected from Actinomycota spp., Glomeromycota spp., Basidiomycota spp., Zygomycota spp., Ascomycota spp, and/or Pezizomycotina spp.

In one embodiment, the liquid component additionally contains enzymes. In one embodiment, the mass fraction of the enzymes in the total mass of the liquid component is 0.05 to 5%, preferably 0.05 to 2%. In one embodiment, the enzymes are selected from cellulases, amylases, invertases, proteases, peroxidases, ureases, phosphatases and/or dehydrogenases.

In one embodiment, the liquid component additionally contains fertilizers. In one embodiment the fertilizers are water-soluble. In one embodiment, the proportion by mass of fertilizer is 5 to 60 m %, preferably 5 to 30 m % of the total mass of liquid component.

In one embodiment, the liquid component is a homogeneous mixture of all constituents.

In one embodiment, the liquid component is an aqueous solution of all of the constituents.

In one embodiment, the liquid component has a viscosity of 1 to 104 mPa*s.

The liquid component can be applied to the seed by methods from the prior art.

The use of interface-active substances in the liquid component advantageously brings about better wetting and thus adhesion of the liquid component during application to the seed.

Furthermore, by combining interface-active substance, plant oil and binding agent, it is advantageously possible to constitute the liquid component in such a way that the seed can be loaded with liquid components significantly more highly than with conventional compositions. In particular for larger seeds with a smooth surface, such as maize or beans, the possibility of loading the seeds is increased many times over, in the case of maize, for example, by 3-6 times.

The reason is a higher viscosity and hydrophobicity, which on the one hand enables better adhesion to the surface of the seeds and on the other hand allows much higher layer thicknesses. In one embodiment, the layer thicknesses are 2 to 8, preferably 3 to 6 times greater than the layer thicknesses known from the prior art.

Advantageously, the effort for subsequent replenishment of nutrients to the plant can be significantly reduced.

By coating the seed with the liquid component according to the invention, additional treatments prior to coating, such as pretreatment (“seed priming”) or treatment with growth regulators and biocontrol agents, are advantageously no longer necessary.

In one embodiment, the loading of the seed with the composition is 0.1 to 100 g per kg of seed, preferably 0.1 to 50 g per kg of seed, in particular 0.1 to 20 g per kg of seed.

In one embodiment, the composition additionally comprises a solid component containing
at least one fertilizer and/or
at least one silicon-based porous material and/or
at least one carbon-based porous material

For the purposes of the invention, fertilizers are substances which, as nutrients, ensure improved plant growth.

In one embodiment, the fertilizers are selected from organic fertilizers and/or mineral fertilizers.

In one embodiment, the fertilizer is a solid in the form of particles and/or powder.

In one embodiment, the fertilizers are selected from iron oxides, zinc oxides, manganese oxides, boron oxides, calcium, magnesium, phosphate, selenium, copper, and molybdenum compounds.

In one embodiment, the particle size of the fertilizers is 10-500 μm, preferably 20 to 200 μm, particularly preferably 50 to 100 μm.

In one embodiment, the silicon-based, porous material is selected from silica, kieselguhr and/or silica gel, zeolites or mixtures of these.

In one embodiment, the silicon-based, porous material has a BET surface area according to ISO 9277 of 20 to 500 m²/g and/or a particle size d50 according to ISO 13302-1 of 0.01 to 150 μm, preferably 0.03 to 80 μm.

In one embodiment, the mass proportion of the silicon-based, porous material is 0.1 to 20%, preferably 5 to 15% of the total mass of the composition.

The silicon-based, porous material advantageously serves as a water reservoir and causes a delayed release of the active ingredients over time. The optimal dosage of fertilizers for the plants can thus advantageously be set.

In one embodiment, the silicon-based, porous material is a chalk.

Advantageously, porous materials based on chalk also release oily substances or volatile substances with a delay.

In one embodiment, the carbon-based, porous material has a BET surface area according to ISO 9277 of 50 to 600 m²/g, preferably 100 to 500 m²/g and/or a pore maximum according to DIN 66134 of 10 nm to 1000 μm.

In one embodiment, the mass fraction of the carbon-based, porous material is 0.1 to 20%, preferably 5 to 15% of the total mass of the composition In one embodiment, the carbon-based, porous material is of plant origin, in particular biochar and/or charcoal. In one embodiment, the carbon-based, porous material is of inorganic origin, in particular activated carbon and/or carbonates.

The pores of the carbon-based porous material advantageously offer an optimal living space for the microorganisms contained in the liquid component. These are thus more strongly integrated into the coating and can develop their effect directly on the seed.

In one embodiment, if at least one silicon-based porous material and at least one carbon-based porous material are contained in the solid component, the particle sizes of the silicon-based, porous material are below the pore size of the carbon-based material, that is, the particles of the silicon-based material are smaller than the pores of the carbon-based material and find space in it.

As a result, the particles of the silicon-based, porous material can advantageously penetrate into the pores and serve as water reservoirs there. This creates an additional improvement in the living conditions for the microorganisms that have settled there, so that they can optimally multiply within the carbon-based material. This means that the seed has far more nutrients available than was possible with conventional seed coatings.

In a further embodiment, the solid component additionally contains at least one inorganic, porous material selected from clay minerals or mixtures of clay minerals, for example bentonites, kaolinites, vermiculites, illites, montmorillonites or diabase rock flour. Quartzes, neosilicates, olivine.

In one embodiment, the mass proportion of the additional, inorganic, porous material in the total mass of the solid component is 1 to 20%, preferably 1 to 10%.

In a further embodiment, the solid component additionally contains dried and comminuted compost material, in particular worm compost, or other composted materials.

The composition and the coating resulting therefrom advantageously contain additional nutrients, humates, porous structure, microorganisms, secondary plant substances, hormones and/or enzymes.

In a further embodiment, the solid component contains binders selected from polyhydroxy compounds. In particular, when it comes to seeds with a very smooth surface, this binding agent causes the coating to adhere better.

In one embodiment, the solid component additionally contains at least one filler material. In one embodiment, the filler material is selected from sawdust, celluloses, plant fibers, chalks, calcium carbonates, algae lime, talc, rock flour, etc.

Depending on the proportion of solid components, the composition is advantageously suitable for coating seeds by film coating, incrustation and/or pelleting.

In one embodiment, the proportion of solid component for film coating is 0 to 35 m %, based on the total mass of the composition.

In one embodiment, the proportion of solid component for incrustation is 30 to 60 m %, based on the total mass of the composition.

In one embodiment, the proportion of solid component for pelletizing is 50 to 70 m %, based on the total mass of the composition.

In one embodiment, the composition according to the invention is applied by a method known in the prior art.

The invention also relates to a process for the production of coated seed with the following steps:
a) Provision of the seed
b) Applying the composition according to the invention to the seed
c) Drying of the coated seed

In one embodiment, the seeds are dried at 10 to 45° C., preferably 20 to 40° C.

In one embodiment, if the composition contains only liquid component, the application of the composition can be repeated several times, wherein step b) then the sub-steps include

b-i) application of the composition

b-ii) allowing the composition to be absorbed.

For the purposes of the invention, allowing the composition to be absorbed means letting the seed with the applied composition rest until the liquid has predominantly or completely penetrated the seed. In one embodiment, the duration of the absorption is 2 to 15 s, preferably 3 to 7 s.

In one embodiment, if the composition contains a liquid component and a solid component, the two substeps

b-1) application of the liquid component

b-2) application of the solid component, take place in step b)

wherein step b-1) takes place before step b-2), after which the two partial steps can be repeated alternately as often as desired until the desired loading of the seed is achieved.

In one embodiment, the liquid component is first applied in step b), followed by the steps
d) Allowing the liquid component to be absorbed
e) Re-application of the liquid component to the seed
f) Adding the solid component to saturation

In one embodiment, steps d) and e) are repeated 1 to 5 times.

A large amount of liquid component can thus advantageously penetrate the seed before the solid component prevents further penetration.

In one embodiment, the steps
g) Renewed application of the liquid component and
h) Repetition of steps f) and g) 1 to 12 times take place after step f)

This procedure, combined with the particularly good adhesion of the composition, can advantageously result in a high loading of composition on the seed.

In one embodiment, 1 to 100 g, preferably 10 to 50 g, in particular 10 to 20 g of the composition are applied per kg of seed.

In one embodiment, the amount of liquid component is 1 to 25 g per kg. of seed, preferably 5 to 20 g/kg of seed, in particular 8 to 16 g/kg of seed.

In one embodiment the method is a film-coating method. In particular, this is used for seed with a large surface, for example maize.

Then step b) takes place by adding the liquid component in the form of a “slurry” or a suspension to the seed via a metering system and coating in a batch treater or a continuous system. The “slurry” is distributed evenly over the seed using a spin disk and centrifugal force. In the case of maize as seed, the coating takes about 14 seconds per 50,000 grains. Optionally, steps d) and e) can follow after step b), that is, the liquid component is first absorbed into the seed and then a new layer of liquid component is applied. Finally, the seed covered with the liquid film is bagged and dried (step c)).

In one embodiment, the method is an incrustation method.

Here, analogous to the film coating process, the seed is first coated with the liquid component, but there is no bagging and drying. Instead, directly after the (possibly multiple) application of the liquid component, step b-2) or f), that is, the addition of the solid component in the form of a powder takes place. The addition takes place until saturation, i.e. until the powder has completely absorbed the liquid.

In one embodiment, after step f) there is a renewed application of liquid component and again metering in of solid component in the form of powder.

Depending on the seed, steps a) to j) take place up to doubling the dead weight of the seed.

In one embodiment, the process is a pelleting process. The steps are carried out analogously to the incrustation process, but in a system known to the person skilled in the art for the pelleting of seeds.

The invention also relates to coated seed comprising a seed and a coating containing a composition according to the invention.

The composition according to the invention is particularly suitable for coating seeds of useful and cultivated plants. The composition according to the invention is particularly suitable for film coating, incrustation or pelleting, depending on the proportion of the solid component.

Suitable types of seeds for the film coating are, for example, maize, grain, sunflowers, soy, pumpkin, paprika, melon, and beans.

Suitable types of seeds for encrustation are, for example, grain, beetroot, beans, alfalfa, lupine, tomato, rape, parsley, carrot.

Suitable types of seeds for pelleting are, for example, rapeseed, beets, salads, parsley, cabbage, onions, leeks, herbs, grass seeds, hemp.

The invention also relates to the use of the composition according to the invention for coating seed.

The invention also relates to seed coated with the composition according to the invention and/or produced in a method according to the invention.

The invention is not restricted to the illustrated and described embodiments, but also includes all embodiments that have the same effect in the sense of the invention.

Furthermore, the invention is also not limited to the specially described combinations of features, but can also be defined by any other combination of specific features of all the individual features disclosed, provided that the individual features are not mutually exclusive or a specific combination of individual features is not explicitly excluded.

The invention is to be explained in more detail below by means of embodiments.

However, the examples are in no way limiting.

In the drawings:

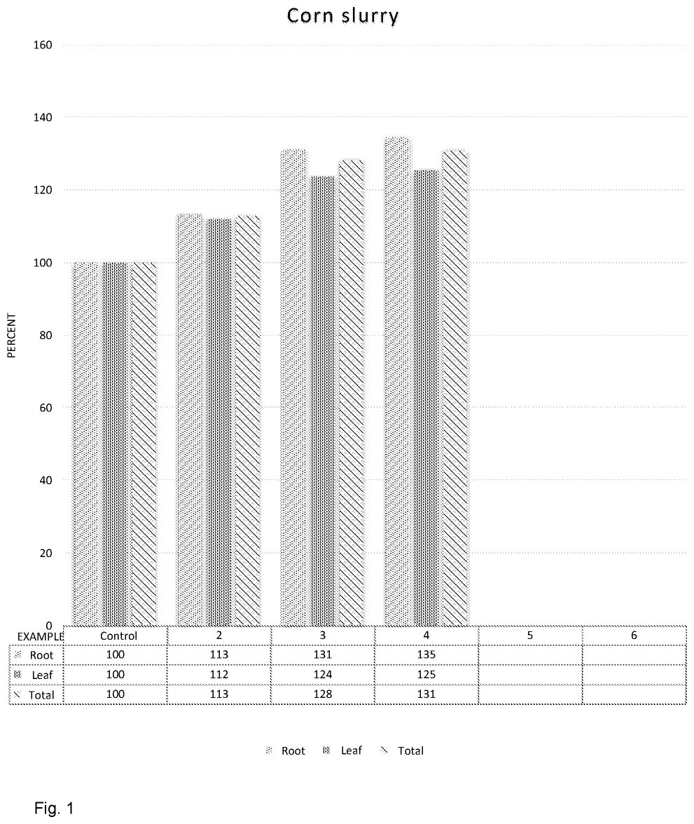

FIG. 1: Shows the increase in the biomass of leaf or root components or the total biomass of maize plants in % that arose from seed which was treated according to one of Examples 1 to 3, compared to plants from untreated seed (control=100%)

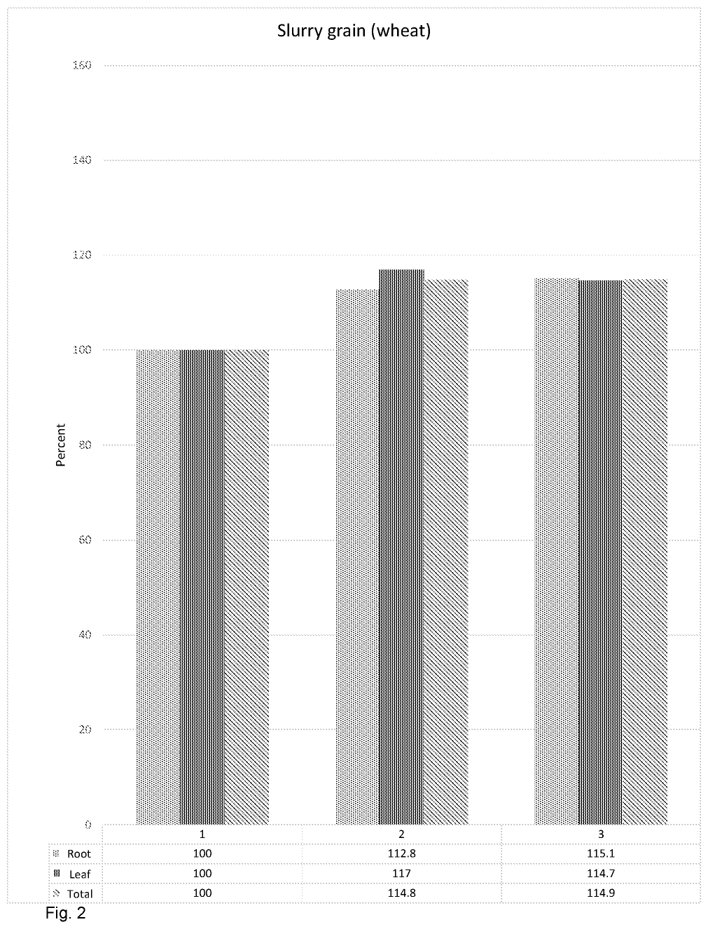

FIG. 2: Shows the increase in the biomass of leaf or root components or the total biomass of wheat plants in % that arose from seed which was treated according to one of Examples 4 (=number 1) or Example 5 (=number 2), compared to plants from untreated seeds (N=100%)

### EXAMPLE 1

Film Coating for Maize Kernels

The amount of coating composition produced is sufficient to coat 1 kg of seeds.
Weighing 5 g of a starch-based polymer with colored pigments into a beaker on a stir plate
Addition of 2 g aqueous compost extract
Addition of 2 g of liquid corn fertilizer
Addition of 3 g of aqueous plant extract
Addition of 0.2 g of 10% acetic acid
Addition of 0.2 g of plant oil containing 20 m % emulsifier
Addition of 0.2 g of rock flour
Addition of 1 g dry herb extract
Add 0.1 g of fertilizer powder for maize
Addition of 0.2 g calcium carbonate

The component mixture is stirred in a beaker for 5 minutes.

The application of the composition to the seeds is carried out with the following steps:
Pour 1 kg of maize seeds into a 10 liter plastic bucket
Spread 15 g of the coating mixture on the edge of the bucket
Close the bucket with lid
Shake the bucket thoroughly for 20 seconds and in a circular motion
Spread the coated seeds on a sieve to dry
Shake the bucket thoroughly for 20 seconds and in a circular motion
Spread the coated seeds on a sieve to dry

### EXAMPLE 2

The composition is produced analogously to Example 1. In addition, 1 g of fertilizer powder containing a micro-nutrient mixture (3% B, 1% Mn, 0.8% Zn, 0.5% Cu, 5% Ca and Mg) is added.

The composition is applied to the maize seed as in Example 1.

### EXAMPLE 3

The composition is produced analogously to Example 2. In addition, 0.5 g of humic acids (not water-soluble) are added.

The composition is applied to the maize seed as in Example 1.

To determine the growth behavior, untreated seed and seed treated according to Examples 1-3 were sown in 5 liter planter pots (nutrient-free substrate, washed sand) and watered. After a 4-week germination and growth phase, the biomass of both the roots and the leaves of the plants and the biomass of the entire plants were determined.

In all three examples of treated seeds, there was a greatly improved growth, which can be demonstrated by an increase in biomass. (FIG. 1)

### EXAMPLE 4

Film Coating for Winter Wheat

The amount of coating composition produced is sufficient to coat 10 kg of seeds

55 g starch-based polymer (e.g. 5.5 ml/10 ml)

10 g of liquid plant extracts

13.5 g compost extract

13.5 g liquid, organic fertilizer

15 g pigments

0.5 g of 10% acetic acid

3 g of solid fertilizer

5 g calcium carbonate

8 g clay minerals

5.2 g rock flour

The component mixture is stirred in a beaker for 5 minutes.

The application of the composition to the seeds is carried out with the following steps:
Pour 1 kg of wheat seeds into a 10 liter plastic bucket
Spread 12 g of the coating mixture on the edge of the bucket
Close the bucket with lid
Shake the bucket thoroughly for 20 seconds and in a circular motion
Spread the coated seeds on a sieve to dry

### EXAMPLE 5

The composition is produced analogously to Example 4. In addition, 1 g of fertilizer powder containing a micro-nutrient mixture (3% B, 1% Mn, 0.8% Zn, 0.5% Cu, 5% Ca and Mg) is added.

The composition is applied to the wheat seed analogously to Example 4.

To determine the growth behavior, untreated seed and seed treated according to Examples 4 and 5 were sown and watered in 5 liter planter pots (nutrient-free substrate, washed sand). After a 4-week germination and growth phase, the biomass of both the roots and the leaves of the plants and the biomass of the entire plants were determined.

In both examples of treated seed, there was a greatly improved growth, which can be demonstrated by an increase in biomass (FIG. 2).

### EXAMPLE 6

Film Coating for Spinach Seeds:

11 g cellulose-based polymer (e.g. 1.1 g/10 ml)

23.5 g of liquid plant extracts

13.5 g liquid, organic fertilizer

15 g pigments

0.5 g of 10% acetic acid

0.2 g plant oil containing 20 m % emulsifier

3 g of solid fertilizer

5 g calcium carbonate

8 g clay minerals

5.2 g rock flour

### EXAMPLE 7

Film Coating for Hemp Seeds

11 g cellulose-based polymer (e.g. 1.1 g/10 ml)

23.5 g of liquid plant extracts

13.5 g liquid, organic fertilizer

15 g pigments

0.5 g of 10% acetic acid

0.2 g plant oil containing 20 m % emulsifier

3 g of solid fertilizer

11 g modified calcium carbonates

2 g of biochar

5.2 g rock flour

1. A composition for a seed coating comprising a liquid component containing
at least one binding agent,
at least one plant oil,
at least one interface-active substance,
at least one carboxylic acid,
at least one extract from plant material

2. Composition according to claim 1, characterized in that the liquid component is a solution and/or suspension in an aqueous and/or organic solvent.

3. Composition according to any of claims 1 to 2, characterized in that the mass proportion of the plant oil or oils is 0.1 to 5% of the total mass of the liquid component.

4. Composition according to any of claims 1 to 3, characterized in that the liquid component contains microorganisms.

5. Composition according to any of claims 1 to 4, characterized in that the liquid component contains humates.

6. Composition according to any of claims 1 to 5, characterized in that the composition additionally comprises a solid component containing
at least one fertilizer and/or
at least one silicon-based porous material and/or
at least one carbon-based porous material.

7. Composition according to any of claims 1 to 6, characterized in that the silicon-based, porous material is selected from silica, kieselguhr, silica gel, zeolites, chalk and/or mixtures of these.

8. Composition according to any of claims 1 to 7, characterized in that the carbon-based, porous material is of plant origin.

9. Method for the production of coated seeds including the steps:
a) Provision of the seeds
b) Applying the composition according to any of claims 1 to 10 to the seed.
c) Drying of the coated seeds

10. Method according to claim 9, characterized in that in step b) the two sub-steps
b-1) Application of the liquid component
b-2) Application of the solid component
take place, with step b-1) taking place before step b-2).

11. Method according to one of claim 9 or 10, characterized in that in step b) the liquid component is applied first, followed by the steps
d) Absorption of the liquid component
e) Re-application of the liquid component to the seed
f) Adding the solid component to saturation

12. Method according to claim 11, characterized in that after step f), the steps
g) Repeating application of the liquid component and
h) Repeating steps f) and g) 1 to 12 times take place after step f) are performed.

13. Process according to any of claims 9 to 12, wherein 1 to 100 g of composition is applied per kg of seed.

14. Use of the composition according to any of claims 1 to 8 for coating seed.

15. Seed coated with a composition according to any of claims 1 to 8 or produced in a method according to any of claims 9 to 13.
